(19) United States
(12) Patent Application Publication
(10) Pub. No.: US 2011/0055841 A1
(43) Pub. Date: Mar. 3, 2011

(54) ACCESS CONTROL APPARATUS, ACCESS CONTROL PROGRAM, AND ACCESS CONTROL METHOD

(76) Inventors: Yuuki Senno, Aichi (JP); Seiji Sakaki, Kanagawa (JP); Norihisa Isogai, Aichi (JP); Chiyomi Hoshino, Aichi (JP); Isao Higashide, Aichi (JP)

(21) Appl. No.: 12/988,872

(22) PCT Filed: Jun. 2, 2009
(86) PCT No.: PCT/JP2009/002445

§ 371 Date: Oct. 21, 2010

(30) Foreign Application Priority Data
Jun. 24, 2008 (JP) 2008-164074

(51) Int. Cl. G06F 9/46

(52) U.S. Cl. 718/103

(57) ABSTRACT

When a new program is set to start processing using a resource such as a memory, and the resource has been allocated to another program, which is currently running, an access control apparatus 100 stops the running program and causes the new program to use the resource if the priority of the new program is higher than the priority of the running program.

### TECHNICAL FIELD

The present invention relates to a control apparatus for controlling access by programs to a resource.

### BACKGROUND ART

In recent years, due to factors such as improvement in Central Processing Unit (CPU) capabilities and expansion of storage elements such as memory, it has become possible to perform a plurality of differing data processing tasks on one device.

For example, in addition to the original telephone function, a single cellular phone terminal can implement a variety of other data processing functions, such as sending and receiving e-mail, interne browsing, photography, music playback, 1seg television reception, etc.

A cellular phone terminal smoothly implements such a variety of functions by running application programs for implementing functions in parallel via, for example, multi-task control.

Technology (see, for example, Patent Literature 1) for restricting access to a resource such as memory when a plurality of programs access the resource at the same time has been proposed as technology to run a plurality of programs on a computer system.

### CITATION LIST

### Patent Literature

[Patent Literature 1] Japanese Patent Application Publication No. H6-161789

### SUMMARY OF INVENTION

### Technical Problem

However, a computer system that uses multi-task control to process a plurality of programs has the following problem. When attempting to run a new program that needs to start processing immediately, if a resource the new program plans to use has already been allocated to another currently running program, the new program will not be able to run until the currently running program releases the resource.

In particular, if the processing by a program that is waiting for a resource to be released before starting is processing that needs to be performed in real time, then a delay in the start of the program's processing will result in the processing no longer being real time.

The present invention has been conceived in light of the above problem, and it is an object thereof to provide an access control apparatus in which the start of processing by a program is not delayed due to waiting for a resource that forms part of a computer system, such as memory, to be released, even in the case where a program attempts to start processing using the resource, yet the resource has been allocated to another program.

### Solution to Problem

In order to solve the above problem, the present invention is a access control apparatus for controlling access to resources by a plurality of programs that access a resource after issuing a request to use the resource, the access control apparatus comprising: a request receiving unit operable to receive a request to use a resource from a program; an information storage unit storing resource access information that includes program information; an access permitting unit operable to permit a program to access a corresponding resource only when the program is indicated by the program information included in the resource access information; and an information rewriting unit operable, when first resource access information, which includes first program information indicating a first program, is stored in the information storage unit, to delete the first resource access information from the information storage unit and add second resource access information, which includes second program information indicating a second program, to the information storage unit upon the request receiving unit receiving a request to use a resource from the second program when a priority predetermined for the second program is higher than a priority predetermined for the first program.

In this context, access refers to reading or writing data.

Also, deleting resource access information from the information storage unit refers to eliminating the resource access information from the information storage unit so that the resource access information does not exist in the information storage unit, or to adding a flag to the resource access information to indicate that the resource access information has been deleted, without actually eliminating the resource access information from the information storage unit, so that even if a program indicated by the eliminated resource access information attempts access, the access permitting unit does not permit access to the corresponding resource.

### ADVANTAGEOUS EFFECTS OF INVENTION

The access control apparatus according to the present invention with the above structure permits a program to access a corresponding resource only when the program is indicated by resource access information stored in the information storage unit. Furthermore, when the request receiving unit receives, from a program, a request to access a second resource that includes part of a first resource to which another program has been given permission to access, the access control apparatus revokes permission to access the first resource from the other program and permits the requesting program to access the second resource if the priority of the requesting program is higher than the priority of the other program.

When a program with a higher priority than a currently running program attempts to access a resource being accessed by the currently running program, this structure, in which the access control apparatus revokes permission to access the resource from the currently running program and permits the program with the higher priority to access the resource, has the effect of not delaying the start of processing of a program with a high priority due to a bottleneck caused by waiting for the resource to be released.

The resource access information may associate the program information with resource information, which indicates a resource accessed by a program indicated by the program information, and when first resource access information, which associates first resource information indicating a first resource with the first program information, is stored in the information storage unit, the information rewriting unit may delete the first resource access information from the information storage unit and add second resource access information, which associates second resource information indicating a second resource with the second program information, to the information storage unit upon the request receiving unit receiving, from the second program, a request to use a second resource that includes at least part of the first resource when the priority predetermined for the second program is higher than the priority predetermined for the first program.

With the above structure, when there is a plurality of resources, access control can be performed for each resource.

When deleting the resource access information from the information storage unit, the information rewriting unit may notify the program indicated by the program information included in the resource access information that permission to access the corresponding resource is revoked.

With the above structure, when a program that corresponds to resource access information deleted from the access permitting unit can no longer access a resource due to the resource access information being deleted from the information storage unit, the program can receive notification that access to the resource has been revoked. Therefore, the program can perform processing corresponding to revocation of access to the resource.

The access control apparatus may further comprise a standby information storage unit storing the resource access information, wherein the information rewriting unit adds the first resource access information to the standby information storage unit when adding the second resource access information to the information storage unit, and when first resource access information is stored in the information storage unit, adds the second resource access information to the standby information storage unit upon the request receiving unit receiving, from the second program, a request to use the second resource that includes at least part of the first resource when the priority predetermined for the second program is not higher than the priority predetermined for the first program.

With the above structure, resource access information that is not stored by the information storage unit is stored by the standby information storage unit, and therefore when resource access information not stored by the information storage unit becomes necessary, it can rapidly be made available.

The information rewriting unit may add third resource access information, which associates third resource information indicating a third resource with third program information indicating a third program, to the information storage unit upon the request receiving unit receiving a request to use the third resource from the third program when the third resource does not include resources indicated by resource information included in every piece of resource access information stored in the information storage unit, and when the third resource access information is stored in the information storage unit, delete the third resource access information from the information storage unit when execution of the third program terminates.

With the above structure, if a request to use a resource not used by other programs is received from a program, the access control apparatus can permit the program to use the resource and, when the program has finished using the resource, make the resource usable by other programs.

The access control apparatus may further comprise an information adding unit operable, when resource access information has been deleted from the information storage unit, when among pieces of resource access information stored by the standby information storage unit, one or more pieces of permissible resource access information exist, the one or more pieces of permissible resource access information not including any resource indicated by the resource information included in every piece of resource access information stored by the information storage unit, to delete a piece of permissible resource access information with a highest priority, predetermined for a program indicated by corresponding program information, from the standby information storage unit and to add the piece of permissible resource access information to the information storage unit.

With the above structure, when resource access information is deleted from the information storage unit, resource access information already stored in the standby information storage unit is added to the information storage unit; therefore, resource access information can be added to the information storage unit rapidly.

When adding the resource access information to the information storage unit, the information adding unit may notify the program indicated by the program information included in the resource access information of permission to access the corresponding resource.

With the above structure, when resource access information is added to the permission information storage unit, the program corresponding to the resource access information added to the information storage unit is notified of permission to access a resource. Therefore, the program that receives such notification can perform processing corresponding to having received permission to access the resource.

The resource access information may additionally associate access method information with the resource information and the program information, the access method information indicating whether a program accesses a resource by shared access, which permits access by other programs, or by exclusive access, which does not permit access by other programs, and the information rewriting unit may delete the first resource access information from the information storage unit and adds the second resource access information to the information storage unit only when at least one of access method information corresponding to the first resource and access method information corresponding to the second resource indicates exclusive access.

With the above structure, the access control apparatus can control access to a resource in accordance with the access method of the resource, thus achieving efficient use of resources.

When resource access information has been deleted from the information storage unit, when the standby information storage unit stores one or more pieces of permissible resource access information, or when among the pieces of resource access information stored by the standby information storage unit, one or more pieces of permissible shared resource access information exist, the one or more pieces of permissible shared resource access information (i) indicating shared access for the access method information and (ii) not including any resource corresponding to resource access information that indicates exclusive access for the access method information among the resource access information stored by the information storage unit, the information adding unit may delete, among the one or more pieces of permissible resource access information and the one or more pieces of permissible shared resource access information, a piece of resource access information with a highest priority, predetermined for a program indicated by corresponding program information, from the standby information storage unit and add the piece of resource access information to the information storage unit.

With the above structure, the access control apparatus can determine which piece of resource access information to add to the information storage unit in accordance with the access method in the pieces of resource access information stored in the standby information storage unit.

The access control apparatus may further comprise a policy storage unit that receives a certificate certifying that a specific program, a specific resource, a specific priority, and a combination thereof are authorized and stores policy information that associates authorized resource information indicating the specific resource, authorized program information indicating the specific program, and authorized priority information indicating the specific priority, wherein the request receiving unit rejects a request to use a resource from a program unless the request (i) is issued by a program indicated by the authorized program information and (ii) is for use of a resource indicated by the authorized resource information associated with the authorized program information, the priority predetermined for the first program is indicated by the priority information in the policy information for when the first program accesses the first resource, and the priority predetermined for the second program is indicated by the priority information in the policy information for when the second program accesses the second resource.

The above structure can be used to achieve an access control apparatus that does not permit an unauthorized program, which is not certified by a certificate, to use resources.

The request receiving unit may provide a program, indicated by program information included in resource access information added to the information storage unit, with a logical address used to access a resource corresponding to the program.

With the above structure, since a program is provided with a logical address for accessing a corresponding resource, the program can access the corresponding resource with the logical address.

The access permitting unit may determine whether to permit access to a resource corresponding to a program when decoding an instruction in the program to read from or write to memory, the program being indicated by program information included in resource access information, and performs error processing when determining not to permit access.

With the above structure, the access control apparatus can determine whether to permit access to a resource upon decoding an instruction to read from or write to memory and can perform error processing when determining not to permit access. Therefore, the access control apparatus can, for example, produce an interrupt when determining not to permit access to the resource and cause the OS to perform processing to terminate the program.

### BRIEF DESCRIPTION OF DRAWINGS

FIG. 1 is a configuration diagram of an access control apparatus.

FIG. 2 shows correspondence between resources and physical addresses.

FIG. 3 shows policy information stored in a policy storage unit.

FIG. 4 shows access restriction information stored in the policy storage unit.

FIG. 5 shows resource access information stored in a permission information storage unit.

FIG. 6 shows resource access information stored in a standby information storage unit.

FIG. 7 is part 1 of a flowchart of when a program requests use of a resource.

FIG. 8 is part 2 of a flowchart of when a program requests use of a resource.

FIG. 9 is a flowchart of when a resource access routine terminates.

FIG. 10 is a flowchart of when the permission information storage unit is updated.

FIG. 11 is a flowchart of changing a logical address into a physical address.

FIG. 12 is a flowchart of updating policy information.

FIG. 13 shows policy information stored in a policy storage unit in a Modification.

FIG. 14 shows access restriction information stored in a policy storage unit in the Modification.

FIG. 15 is part 1 of a figure showing when physical addresses overlap in the Modification.

FIG. 16 is part 2 of a figure showing when physical addresses overlap in the Modification.

FIG. 17 is part 1 of a flowchart of when a program requests use of a resource in the Modification.

FIG. 18 is part 2 of a flowchart of when a program requests use of a resource in the Modification.

### DESCRIPTION OF EMBODIMENTS

### Embodiment

As an embodiment of an access control apparatus according to the present invention, the following is a description of an access control apparatus for controlling access to resources by a plurality of programs.

### <Configuration>

The access control apparatus according to the present invention receives a request to use a resource only from an application program whose authorization has been certified by a certificate authority and, based on a priority of resource use for the application program, controls exclusive access to the resource by the application program.

The following describes the configuration of the access control apparatus according to the present invention with reference to the drawings.

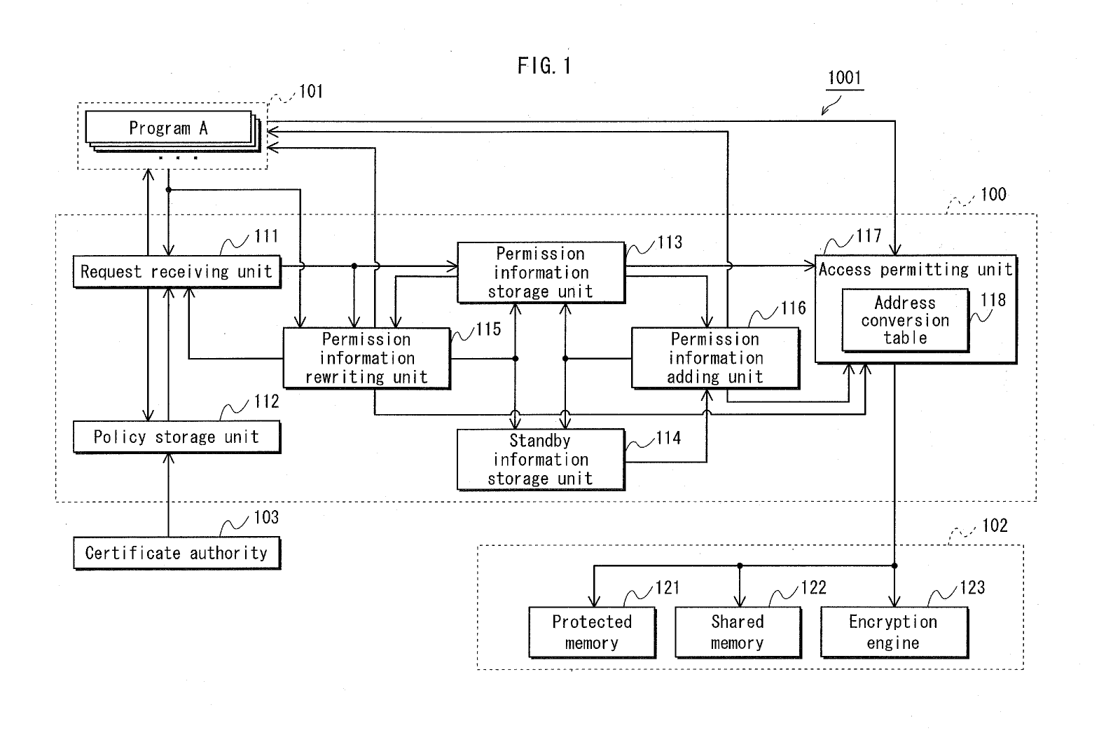

FIG. 1 is a configuration diagram showing the configuration of a resource access system 1000 according to the present invention that includes an access control apparatus 100, group of programs 101, resources 102, and a certificate authority 103.

While not shown in the figure, the access control apparatus 100 is implemented by hardware such as a processor, memory, memory controller, timer, hard disc, etc., and by an Operating System (OS) running on the hardware. The access control apparatus controls access to the resources 102 by a plurality of application programs forming the group of programs 101.

Access to a resource by an application program refers to the processor reading and executing instructions that configure the application program, such as instructions to read from or write to memory, thereby reading data in the resource, writing data to the resource, etc.

The group of programs 101 includes a plurality of application programs (hereinafter referred to simply as “programs”) that access the resources 102. Each program runs on the OS.

The resources 102 are accessed by indicating a physical address to the memory controller. The access control apparatus 100 controls access to the resources 102 by each program forming the group of programs 101.

The certificate authority 103 certifies authorization of access to a resource by a program. The access control apparatus 100 only permits access to a resource by a program when the certificate authority 103 certifies the access.

The following is a description of the group of programs 101, resources 102, certificate authority 103, and access control apparatus 100, in that order, with reference to the figures.

### <Group of Programs 101>

The programs forming the group of programs 101 each include a processing routine formed by a series of processes that access the resources 102 one or more times (hereinafter referred to as a “resource access processing routine”) and a processing routine that notifies the OS of the starting address of processing routines, among the processing routines included in the program, that operate after receiving notification from the OS (hereinafter referred to as an “OS notification processing routine”).

When a series of processes to access the resources 102 one or more times starts, the resource access processing routine issues a request to use the resources 102 to a request receiving unit 111, and when the series of processes ends, the resource access processing routine notifies the permission information rewriting unit 115 of termination of execution of the resource access processing routine.

In order for a program to issue a request to the request receiving unit 111 to use the resources 102, the OS is provided with a resource use Application Program Interface (API). When a program indicates a resource, the resource use API is called and starts processing whereby the request receiving unit 111 creates resource access information from information identifying the program that called the resource use API, information identifying the indicated resource, and policy information stored by the policy storage unit 112.

When this resource use API is called by a program, the request receiving unit 111 returns to the program, as a return value, the starting address of a logical address space used when the program accesses the resource (hereinafter referred to as a “starting logical address”).

To access the resources 102, the resource access processing routine indicates a logical address created with reference to the starting logical address, which was returned as a return value, and then accesses the resources 102.

The OS is further provided with a termination processing API and an address notifying API. When a program calls the termination processing API in order to notify the permission information rewriting unit 115 of termination of execution of a resource access processing routine, the termination processing API starts processing whereby the permission information rewriting unit 115 deletes resource access information that is stored by the permission information storage unit 113 and that corresponds to the program that called the termination processing API. When a program calls the address notifying API and indicates a starting address of a processing routine in order to notify the OS of the starting address, the address notifying API causes the OS to store the starting address of the processing routine.

In this embodiment, when deleting resource access information, the resource access information is eliminated, i.e. caused not to exist.

### <Resources 102>

The resources 102 are accessed by indicating a physical address to the memory controller. The resources 102 are composed of a protected memory 121, shared memory 122, and encryption engine 123.

The encryption engine 123 is hardware for encryption processing. By allocating a register for the encryption engine 123 as a memory address, the register can be read from, written to, etc. via a similar interface as other memory units.

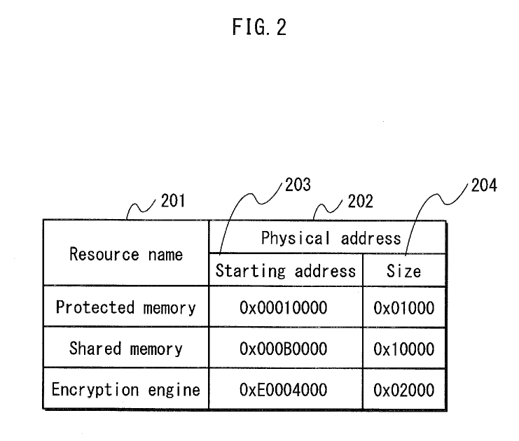

FIG. 2 shows the physical addresses allocated to the protected memory 121, shared memory 122, and encryption engine 123 composing the resources 102.

The protected memory 121 is memory with a starting physical address of 0x00010000 and a size of 0x010000. The physical addresses allocated to the protected memory 121 are 0x00010000 to 0x0001FFFF.

Similarly, the shared memory 122 is memory to which physical addresses of 0x000B0000 to 0x000BFFFF are allocated, and the encryption engine 123 is encryption hardware to which physical addresses of 0xE0004000 to 0xE0005FFFF are allocated.

### <Certificate Authority 103>

The certificate authority 103 is a certificate issuing system. First, the certificate authority 103 receives information indicating a program, information on a resource the program is to access, information on the priority when the program accesses the resource, and information on the access method by which the program accesses the resource. The certificate authority 103 then certifies access by a specific program to a specific resource at a specific priority via a specific access method and issues a corresponding certificate.

When access by a specific program to a specific resource at a specific priority via a specific access method does not cause any problem, the certificate authority 103 creates policy information, which associates a specific program with a specific resource, a specific priority, and a specific access method. The certificate authority 103 then encrypts the created policy information with a private key that differs for each priority and issues the encrypted policy information as a certificate.

### <Access Control Apparatus 100>

The access control apparatus 100 receives a request to use the resources 102 only from a program whose authorization has been certified by the certificate authority 103 and, based on the received priority of resource use for the program, controls access to the resources 102 by the program. The access control apparatus 100 is composed of the request receiving unit 111, the policy storage unit 112, the permission information storage unit 113, the standby information storage unit 114, the permission information rewriting unit 115, a permission information adding unit 116, and an access permitting unit 117, which includes an address conversion table 118.

The following is an explanation, in order, of the blocks composing the access control apparatus 100, with reference to the drawings.

### <Policy Storage Unit 112>

The policy storage unit 112 is a block that stores policy information. The policy storage unit 112 stores access restriction information (described below) and uses a public key corresponding to a private key to decrypt the certificate issued by the certificate authority 103 into policy information. The policy storage unit 112 only stores this policy information if it at least fulfills the requirement of not violating the restriction in the access restriction information.

Also, the policy storage unit 112 is provided with a display not shown in the drawings. Upon decrypting a certificate, the policy storage unit 112 displays a message indicating successful registration when storing the decrypted policy information and displays a message indicating registration failure when not storing the decrypted policy information.

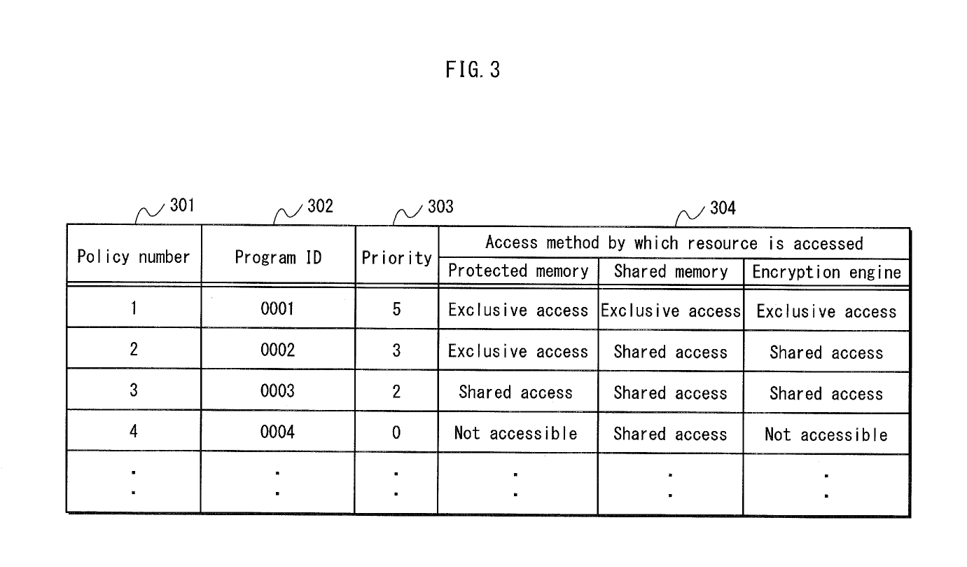

FIG. 3 shows policy information stored in the policy storage unit 112.

The policy information indicates that access to the protected memory 121, shared memory 122, or encryption engine 123 is either permitted or denied for a program specified by a program identification (ID) 302 at a priority indicated by the priority 303, the access method being either exclusive or shared.

In this context, exclusive access refers to not permitting access to a resource by other programs when a program with exclusive access is accessing the resource. Shared access refers to permitting access to a resource by other programs when a program with shared access is accessing the resource.

For example, in FIG. 3, policy information with a policy number 301 of 2 indicates that a program with a program ID of 0002 has a priority of 3 and is permitted exclusive access to the protected memory 121, shared access to the shared memory 122, and shared access to the encryption engine 123.

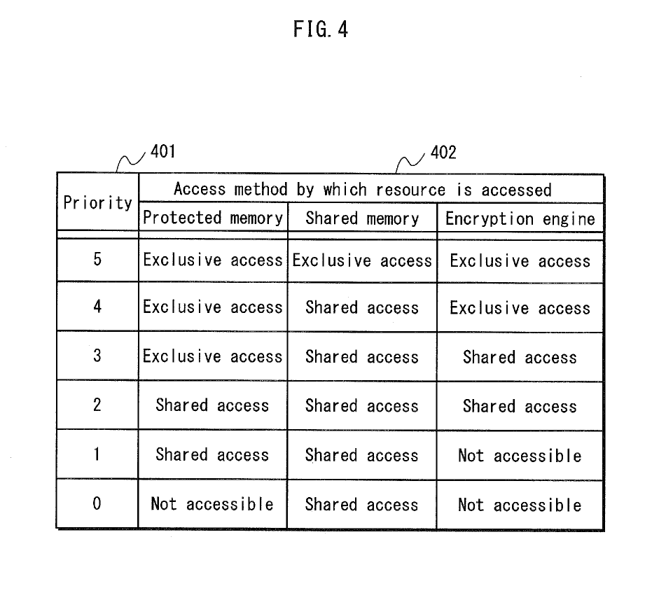

FIG. 4 shows access restriction information stored in the policy storage unit 112.

Access restriction information indicates that access to the protected memory 121, shared memory 122, or encryption engine 123 is either permitted or denied for a program having a priority as indicated by a priority 401, the access method being either exclusive or shared. The access restriction information is included in advance as part of the policy storage unit 112.

For example, in FIG. 4, a program with a priority of 3 is indicated as being permitted exclusive access to the protected memory 121, shared access to the shared memory 122, and shared access to the encryption engine 123. Accordingly, for policy information with a priority of 3, the policy storage unit 112 stores policy information restricted to indicating that the program has exclusive access to the protected memory 121, shared access to the shared memory 122, and shared access to the encryption engine 123.

### <Request Receiving Unit 111>

The request receiving unit 111 is a block that, when one of the programs in the group of programs 101 requests to use the resources 102, creates resource access information, which is information associating information on the program, information on the resource, information on the priority, and information on the access method. The request receiving unit 111 then returns a starting logical address for the program as a return value.

When receiving a request from a program to use the resources 102, the request receiving unit 111 determines whether there is policy information corresponding to the program that issued the request among the policy information stored in the policy storage unit 112. If so, then if and only if corresponding resource access information does not exist in the permission information storage unit 113, the request receiving unit 111 creates resource access information by referring, in the corresponding policy information, to information on the program, on the resource, on the priority, and on the access method. Upon receiving notification of a starting logical address from either the permission information rewriting unit 115 or the permission information adding unit 116, the request receiving unit 111 returns the notified starting logical address for the program issuing the request as a return value.

In this context, by creating the resource access information, the request receiving unit 111 is considered to have received a request for use of a resource from a program.

Note that if policy information corresponding to the program issuing the request is not in the policy storage unit 112, the request receiving unit 111 stops execution of the program issuing the request.

### <Permission Information Storage Unit 113>

The permission information storage unit 113 is a block storing a starting logical address in correspondence with resource access information, among the pieces of resource access information created by the request receiving unit 111, that indicates access to the resources 102 by a program as permitted by the access control apparatus 100.

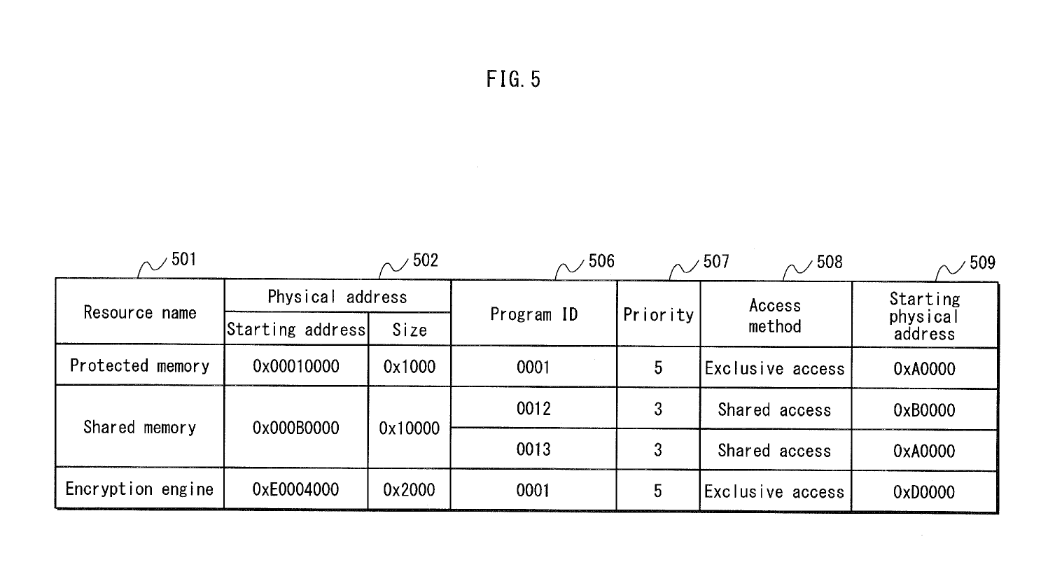

FIG. 5 shows resource access information that the permission information storage unit 113 stores in correspondence with a starting logical address.

The permission information storage unit 113 stores resource access information in correspondence with a starting logical address 509. The resource access information is information indicating, in correspondence, a resource specified by a resource name 501 and a physical address 502, a program specified by a program ID 506, a priority specified by a priority 507, and an access method specified by an access method 508.

In this context, the starting logical address 509 is created by the permission information rewriting unit 115 or the permission information adding unit 116 based on resource access information only when the resource access information is stored in the permission information storage unit 113 for the first time.

For example, in FIG. 5, the permission information storage unit 113 stores, in correspondence, (i) resource access information indicating that a program having a program ID of 0001 has exclusive access, with a priority of 5, to the protected memory 121, and (ii) a starting logical address of 0xA0000 of the program with the program ID of 0001.

### <Standby Information Storage Unit 114>

The standby information storage unit 114 stores, in correspondence, (i) resource access information, from among the pieces of resource access information created by the request receiving unit 111, for a program not permitted access to resources, i.e. for a program that is on standby to receive permission for access to a resource, (ii) a starting logical address, and (iii) a storage starting time.

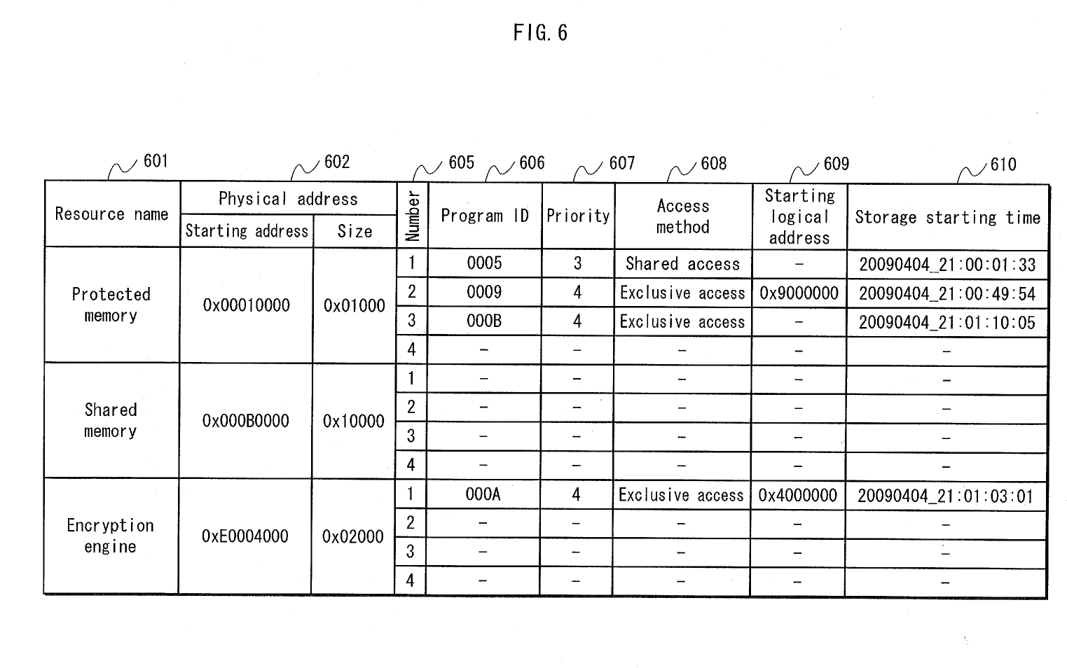

FIG. 6 shows resource access information that the standby information storage unit 114 stores in correspondence with a starting logical address and a storage starting time.

The standby information storage unit 114 stores, in correspondence, (i) resource access information, which is information indicating, in correspondence, a resource specified by a resource name 601 and a physical address 602, a program specified by a program ID 606, a priority specified by a priority 607, and an access method specified by an access method 608, (ii) a starting logical address 609, and (iii) a storage starting time 610 indicating the time that the resource access information was stored.

As described above, a starting logical address 609 is provided only for resource access information that has been stored in the permission information storage unit 113. Accordingly, no corresponding starting logical address exists for resource access information that has not been stored in the permission information storage unit 113.

For example, in FIG. 6, the standby information storage unit 114 stores, in correspondence, (i) resource access information indicating that a program having a program ID 0009 is in waiting slot number 2 for the protected memory 121 and accesses the protected memory 121 exclusively with a priority of 4, (ii) information providing 0x90000 as the starting logical address of the program having a program ID 0009, and (iii) information indicating 21:00:01:33 on Apr. 4, 2009 as the date and time the resource access information was stored.

### <Permission Information Rewriting Unit 115>

The permission information rewriting unit 115 is a block provided with (i) a function, when the request receiving unit 111 has created resource access information, to add the created resource access information to either the permission information storage unit 113 or the standby information storage unit 114, and (ii) a function to delete a piece of resource access information stored in the permission information storage unit 113 upon receiving notification of termination of execution of a resource access processing routine from a program corresponding to the piece of resource access information.

When the resource access information created by the request receiving unit 111 indicates that the access control apparatus 100 permits access to a resource by a program, the resource access information is added to the permission information storage unit 113. When the resource access information indicates denial of permission, the resource access information is stored in the standby information storage unit 114.

Below, the functions of the permission information rewriting unit 115 are described for a variety of situations.

When adding resource access information to the permission information storage unit 113, the permission information rewriting unit 115 operates as follows. 1) Based on the resource access information, the permission information rewriting unit 115 creates a starting logical address and information to convert a logical address into a physical address (hereinafter “address conversion information”). 2) The permission information rewriting unit 115 then adds the resource access information to the permission information storage unit 113 in correspondence with the created starting logical address. 3) The permission information rewriting unit 115 associates the created address conversion information with information indicating a program, sets these pieces of information as address conversion table elements, and adds the address conversion table elements to the address conversion table 118 stored by the access permitting unit 117. 4) The permission information rewriting unit 115 notifies the request receiving unit 111 of the created starting logical address and 5) notifies the program corresponding to the resource access information of permission information, which indicates permission to access the corresponding resource.

Upon being notified of permission information by the permission information rewriting unit 115, a program starts to execute a resource access processing routine.

When attempting to add resource access information created by the request receiving unit 111 to the permission information storage unit 113, if a resource matching the resource indicated by the created resource access information is among the resources indicated by the resource access information already stored by the permission information storage unit 113, the permission information rewriting unit 115 deletes the resource access information that is stored in the permission information storage unit 113 and that indicates the matching resource, adding this resource access information to the standby information storage unit 114.

When deleting resource access information stored by the permission information storage unit 113, the permission information rewriting unit 115 (i) notifies the corresponding program of deletion information indicating that permission to access the corresponding resource is revoked and (ii) deletes corresponding address conversion table elements from the address conversion table 118 in the access permitting unit 117.

Upon being notified of deletion information by the permission information rewriting unit 115, a program performs post-processing so that the program terminates.

### <Permission Information Adding Unit 116>

The permission information adding unit 116 is a block provided with a function to add resource access information stored by the standby information storage unit 114 to the permission information storage unit 113 when the resource access information stored by the permission information storage unit 113 is updated.

Below, the functions of the permission information adding unit 116 are described for a variety of situations.

When the resource access information stored by the permission information storage unit 113 is updated, if resource access information indicating a resource that can be added to the permission information storage unit 113 (hereinafter “applicable resource access information”) exists among the resource access information stored by the standby information storage unit 114, the permission information adding unit 116 selects the resource access information to be stored in the permission information storage unit 113 from among the applicable resource access information (hereinafter “additional resource access information”), deletes the selected additional resource access information from the standby information storage unit 114, and adds the additional resource access information to the permission information storage unit 113.

A resource that can be added to the permission information storage unit 113 refers to either 1) a resource whose access method is exclusive and which is not included among the resources indicated by all of the pieces of resource access information stored by the permission information storage unit 113, or 2) a resource whose access method is shared and which is not included among the resources whose access method is exclusive among the resources indicated by the pieces of resource access information stored by the permission information storage unit 113.

Details on the selection requirements for additional resource access information are provided below.

When the permission information adding unit 116 adds resource access information to the permission information storage unit 113, and the starting logical address corresponding to the resource access information to add is not stored in the standby information storage unit 114, the permission information adding unit 116 operates as follows. 1) Based on the resource access information, the permission information adding unit 116 creates a starting logical address and address conversion information. 2) The permission information adding unit 116 adds the resource access information to the permission information storage unit 113 in correspondence with the created starting logical address. 3) The permission information adding unit 116 associates the created address conversion information with information indicating a program, sets these pieces of information as address conversion table elements, and adds the address conversion table elements to the address conversion table 118 stored by the access permitting unit 117. 4) The permission information adding unit 116 notifies the request receiving unit 111 of the created starting logical address and 5) notifies the program corresponding to the resource access information of permission information, which indicates permission to access the corresponding resource.

Upon being notified of permission information by the permission information adding unit 116, a program starts to execute a resource access processing routine.

When the permission information adding unit 116 adds resource access information to the permission information storage unit 113, and the starting logical address corresponding to the resource access information to add is stored in the standby information storage unit 114, the permission information adding unit 116 operates as follows. 1) Based on the resource access information, the permission information adding unit 116 creates address conversion information. 2) The permission information adding unit 116 adds the resource access information to the permission information storage unit 113 in correspondence with the starting logical address. 3) The permission information adding unit 116 associates the created address conversion information with information indicating a program, sets these pieces of information as address conversion table elements, and adds the address conversion table elements to the address conversion table 118 stored by the access permitting unit 117. 4) The permission information adding unit 116 notifies the request receiving unit 111 of the created starting logical address and 5) boots the program corresponding to the resource access information.

### <Access Permitting Unit 117>

The access permitting unit 117 is a block for reading from or writing to a resource. When the decoder in the processor decodes an instruction, included in a program, to read from or write to a resource, the access permitting unit 117 converts the logical address designated by the instruction to a corresponding physical address by referring to the address conversion table 118. The access permitting unit 117 then uses the converted physical address to cause the memory controller, which manages access to the resources 102, to operate. Part of the access permitting unit 117 is composed of part of the decoder in the processor.

The address conversion table 118 stored by the access permitting unit 117 stores a plurality of address conversion table elements, which are pieces of information associating information that indicates a program with address conversion information, which is for converting a logical address into a physical address.

The access permitting unit 117 converts a logical address into a physical address by referring to the address conversion information corresponding only to programs in the address conversion table elements stored by the address conversion table 118.

When a program other than the programs corresponding to the address conversion table elements composing the address conversion table 118 reads from or writes to the resources 102, the access permitting unit 117 generates an exception and causes the OS to stop running the program.

### <Operations>

<Operations when Receiving a Request to Use a Resource>

With reference to the drawings, the following is a description of operations when receiving a request from a program to use a resource.

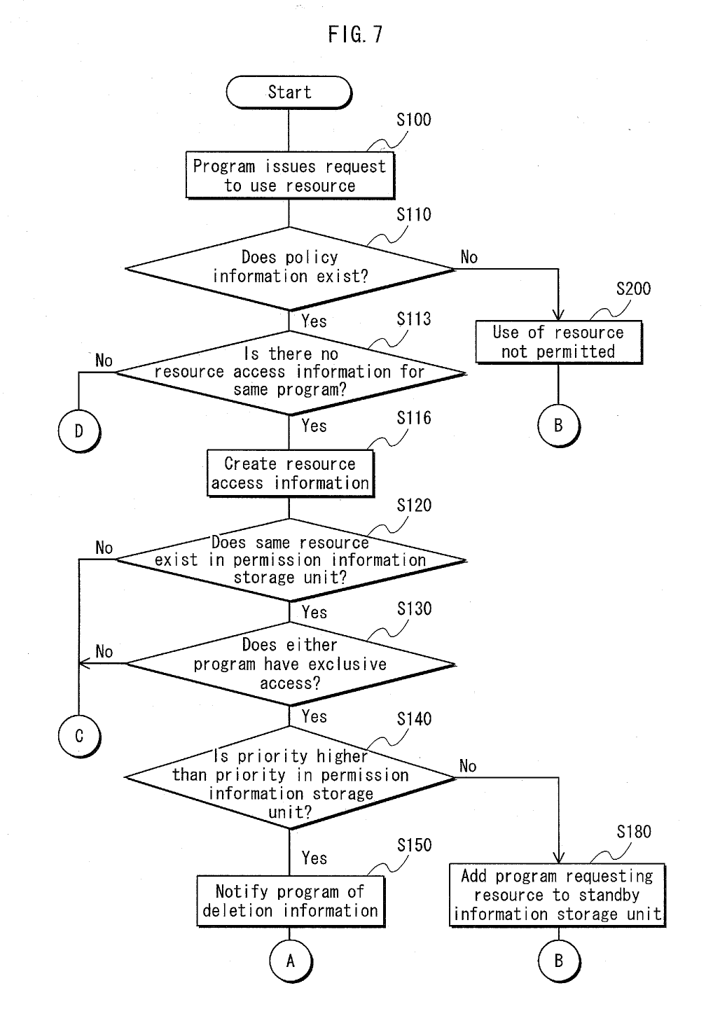

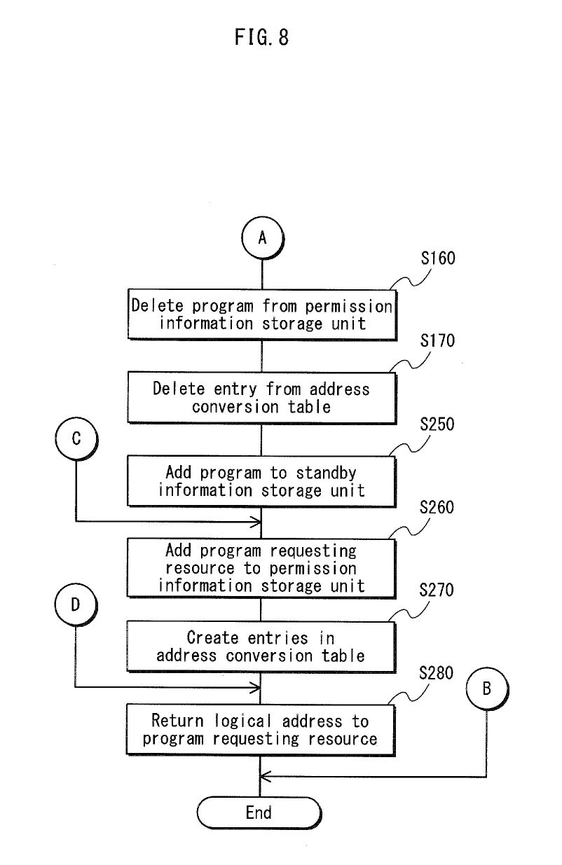

FIGS. 7 and 8 are a flowchart showing when a request to use a resource 102 is received from a program in the group of programs 101.

When a program in the group of programs 101 issues a request to the request receiving unit 111 to use the resources 102 (step S100), the request receiving unit 111 determines whether policy information corresponding to the requesting program exists among the policy information stored by the policy storage unit 112 (step S110). If such policy information does exist (step S110: Yes), the request receiving unit 111 determines whether resource access information corresponding to the requesting program exists in the permission information storage unit 113 (step S113). If corresponding resource access information is not found (step S113: Yes), the request receiving unit 111 creates resource access information corresponding to the requesting program (step S116), thereby receiving the request to use a resource.

When the request receiving unit 111 receives the request to use a resource, the permission information rewriting unit 115 determines whether resource access information (hereinafter “overlapping resource access information”) indicating the same resource (hereinafter “overlapping resource”) as the resource access information created by the request receiving unit 111 (hereinafter “new resource access information”) is stored in the permission information storage unit 113 (step S120).

If overlapping resource access information is stored in the permission information storage unit 113 (step S120: Yes), then if either the program indicated by the new resource access information (hereinafter “new program”) or the program indicated by the overlapping resource access information (hereinafter “overlapping program”) accesses the overlapping resource via exclusive access (step S130: Yes), then the permission information rewriting unit 115 compares the priority of access to the overlapping resource by the new program with the priority of access to the overlapping resource by the overlapping program (step S140). If the priority of access to the overlapping resource by the new program is higher than the priority of access to the overlapping resource by the overlapping program (step S140: Yes), the permission information rewriting unit 115 notifies the overlapping program of deletion information (step S150).

When the permission information rewriting unit 115 notifies the overlapping program of deletion information, the overlapping program performs post-processing and terminates.

After a predetermined time passes after providing notification of deletion information, the permission information rewriting unit 115 deletes the overlapping resource access information and the corresponding starting logical address from the permission information storage unit 113 (step S160).

This predetermined time is a pre-established time necessary for the overlapping program to perform post-processing and terminate. In this embodiment, the predetermined time is uniformly set for all programs, and the permission information rewriting unit 115 uses a timer not shown in the drawings to measure the predetermined time.

Upon deleting the overlapping resource access information and the corresponding starting logical address from the permission information storage unit 113, the permission information rewriting unit 115 deletes corresponding address conversion table elements from the address conversion table 118 (step S170) and adds the overlapping resource access information to the standby information storage unit 114 in association with a corresponding starting logical address (step S250).

Upon adding overlapping resource access information to the standby information storage unit 114, the permission information rewriting unit 115 creates address conversion table elements corresponding to new access information, stores new resource access information in the permission information storage unit 113 in correspondence with the created starting logical address (step S260), and adds the created address conversion table elements to the address conversion table 118 (step S270).

Upon executing step S270, or if the request receiving unit 111 finds resource access information corresponding to the requesting program in the permission information storage unit 113 in step S113 (step S113: No), the permission information rewriting unit 115 notifies the request receiving unit 111 of the starting logical address corresponding to the requesting program. The permission information rewriting unit 115 then notifies the requesting program of permission information.

Upon being notified of a starting logical address by the permission information rewriting unit 115, the request receiving unit 111 returns the notified starting logical address to the requesting program as a return value (step S280) and terminates operations for receiving a request to use a resource.

Upon receiving permission information and the starting logical address, the program starts a resource access processing routine.

In step S140, if the priority of access to the overlapping resource by the new program is not higher than the priority of access to the overlapping resource by the overlapping program (step S140: No), the permission information rewriting unit 115 adds the new resource access information to the standby information storage unit 114 (step S180) and terminates operations for receiving a request to use a resource.

If, in step S120, overlapping resource access information is not stored in the permission information storage unit 113 (step S120: No), or if, in step S130, both the new program and the overlapping program access the overlapping resource via shared access (step S130: No), the permission information rewriting unit 115 performs the operations in the above steps S260-S280 and terminates operations for receiving a request to use a resource.

If, in step S110, corresponding policy information does not exist (step S110: No), the request receiving unit 111 stops execution of the program (step S200) and terminates operations for receiving a request to use a resource.

### <Operations When a Resource Access Processing Routine Terminates>

Operations when a resource access processing routine terminates are described next with reference to the drawings.

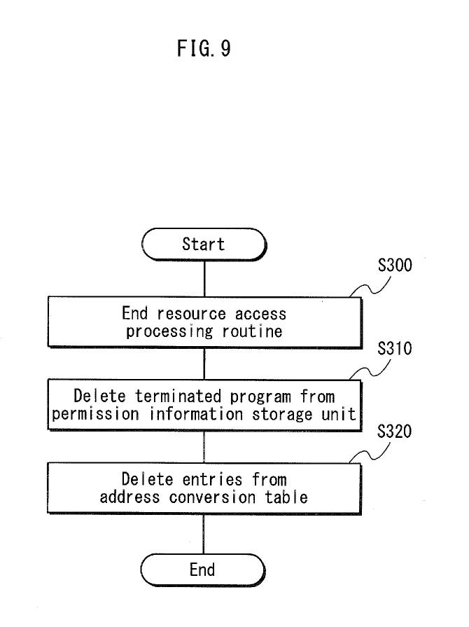

FIG. 9 is a flowchart of operations when a resource access processing routine terminates.

When a resource access processing routine terminates, a program notifies the permission information rewriting unit 115 of termination of execution (step S300).

Upon receiving notification of termination of execution from a program, the permission information rewriting unit 115 deletes the resource access information and the corresponding starting logical address from the permission information storage unit 113 (step S310), deletes corresponding address conversion table elements from the address conversion table 118 (step S320), and terminates operations for when a resource access processing routine terminates.

### <Operations When the Permission Information Storage Unit 113 is Updated>

With reference to the drawings, the following is a description of operations when information stored by the permission information storage unit 113 is updated.

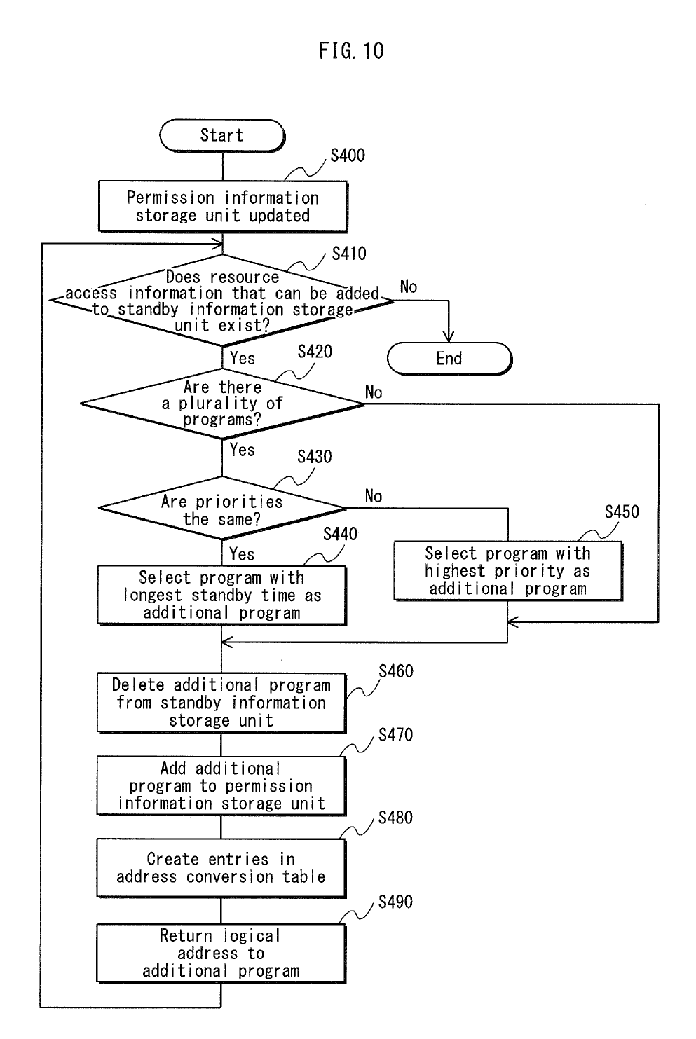

FIG. 10 is a flowchart of operations when information stored by the permission information storage unit 113 is updated, for example when receiving a request to use a resource from a program, when a running program terminates, etc.

When the information stored by the permission information storage unit 113 is updated (step S400), then if a resource that can be added to the permission information storage unit 113 exists in one or more pieces of resource access information stored by the standby information storage unit 114 (step S410: Yes), and if there are more than one such pieces of resource access information (step S420: Yes), the permission information adding unit 116 compares the priority of the pieces of resource access information (step S430).

As a result of comparing the priorities, if there are more than one pieces of resource access information having the highest priority (step S430: Yes), the permission information adding unit 116 selects the piece of resource access information with the earliest time stored in the standby information storage unit 114 as additional resource access information (step S440). If there is one piece of resource access information with the highest priority (step S430: No), the permission information adding unit 116 selects this resource access information with the highest priority as additional resource access information (step S450). If there is only one piece of resource access information in step S420 (step S420: No), the piece of resource access information is selected as additional resource access information.

Upon selecting additional resource access information, if the corresponding starting logical address is stored in the standby information storage unit 114, the permission information adding unit 116 1) adds the additional resource access information to the permission information storage unit 113 in correspondence with the starting logical address (step S470), 2) creates address conversion table elements, adds the created address conversion table elements to the address conversion table 118 (step S480), and notifies the request receiving unit 111 of the starting logical address, 3) deletes the additional resource access information and corresponding starting logical address and storage starting time from the standby information storage unit 114, and 4) boots the program corresponding to the additional resource access information.

Upon selecting additional resource access information, if the corresponding starting logical address is not stored in the standby information storage unit 114, the permission information adding unit 116 1) creates a starting logical address and adds the additional resource access information to the permission information storage unit 113 in correspondence with the starting logical address (step S470), 2) creates address conversion table elements, adds the created address conversion table elements to the address conversion table 118 (step S480), and notifies the request receiving unit 111 of the starting logical address, 3) deletes the additional resource access information and corresponding starting logical address and storage starting time from the standby information storage unit 114, and 4) notifies the program corresponding to the additional resource access information of permission information.

Upon receiving notification of a starting logical address, the request receiving unit 111 returns the notified starting logical address to the corresponding program as a return value (step S490).

Details on operations to convert a logical address into a physical address are provided below.

Upon notifying a program corresponding to additional resource access information of a starting logical address (step S490), the request receiving unit 111 returns to step S410 and continues processing thereafter.

In step S410, if there is no resource that can be added in the resource access information stored by the standby information storage unit 114 (step S410: No), the permission information adding unit 116 terminates operations for when the permission information storage unit 113 is updated.

<Operations by which a Program Accesses a Resource>

Operations by which a program accesses a resource are described next with reference to the drawings.

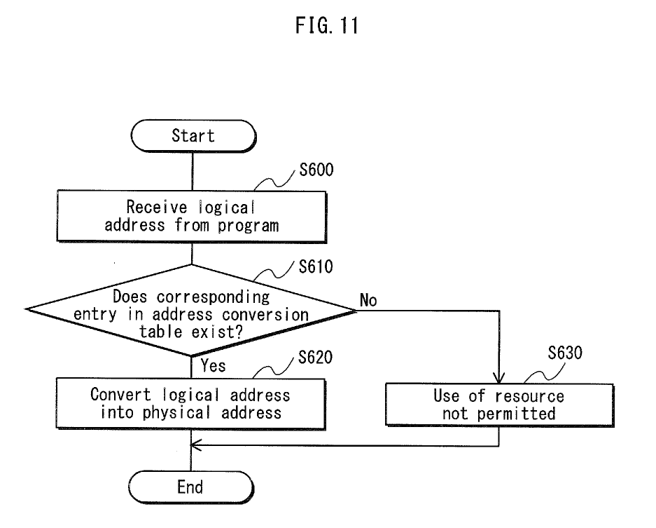

FIG. 11 is a flowchart showing operations to read from or write to the resources 102 when the decoder in the processor decodes an instruction, included in a program, to read from or write to a resource.

When the access permitting unit 117 receives, from the processor's instruction fetch unit, an instruction for reading from or writing to the resources 102 via indication of a logical address (step S600), the access permitting unit 117 starts to decode the received instruction.

Upon starting to decode an instruction, the access permitting unit 117 confirms whether corresponding address conversion table elements are in the address conversion table 118 (step S610). If so (step S610: Yes), then based on the corresponding address conversion information, the access permitting unit 117 converts the logical address into a physical address (step S620) and, using the converted physical address, completes decoding of the received instruction.

Furthermore, the access permitting unit 117 uses the decoded instruction, which includes the physical address, to cause the memory controller that manages access to the resources 102 to operate and read from or write to the resources 102. The access permitting unit 117 thus terminates operations for a program to access a resource.

In step S610, if there is no corresponding address conversion table (step S610: No), the access permitting unit 117 stops execution of the program by generating an interrupt and causing the OS to run a processing routine that stops execution of the program (step S630). The access permitting unit 117 thus terminates operations for a program to access a resource.

### <Operations to Update Policy Information>

Operations when receiving a certificate from the certificate authority 103 are described next with reference to the drawings.

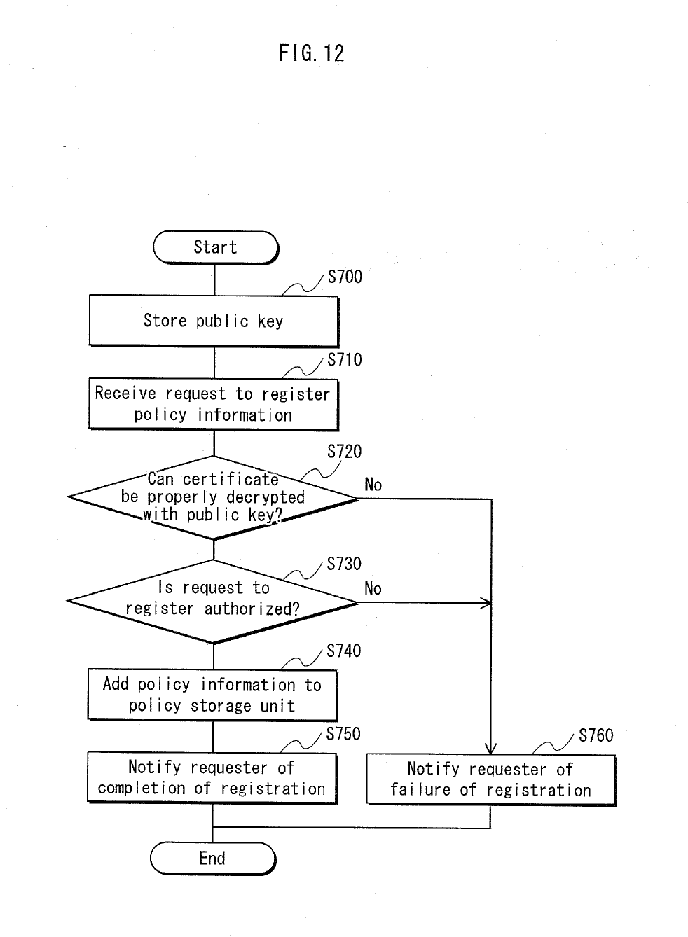

FIG. 12 is a flowchart showing operations when receiving a certificate from the certificate authority 103 and registering policy information in the policy storage unit 112.

When access by a received program to a specific resource at a specific priority via a specific access method does not cause any problem, the certificate authority 103 certifies that the received program can access a specific resource at a specific priority via a specific access method. The certificate authority 103 then creates policy information, which associates a specific program with a specific resource, a specific priority, and a specific access method.

The certificate authority 103 encrypts the created policy information with a private key that differs for each priority and submits the encrypted policy information to the program owner as a certificate.

The certificate authority 103 publicly discloses a public key corresponding to the private key.

Upon receiving the certificate, the program owner inputs the certificate into the policy storage unit 112.

The owner of the program that access the resources 102 via the access control apparatus 100 submits the program, the resource used by the program, the priority when using the resource, and the access method when using the resource to the certificate authority 103.

Upon certifying authorization of a specific program to access a specific resource at a specific priority via a specific access method, the certificate authority 103 first creates policy information and then encrypts, with a private key that differs for each priority, the created policy information as a certificate.

The public key corresponding to the private key is a key that has been publicly disclosed.

The policy storage unit 112 stores a public key corresponding to the private key used when the certificate authority creates a certificate (step S700).

The program owner who wants to register the policy information created by the certificate authority 103 in the policy storage unit 112 inputs the certificate issued by the certificate authority 103 in the policy storage unit 112. When the certificate is input into the policy storage unit 112 (step S710), the policy storage unit 112 uses 6 public keys corresponding to 6 priorities, from 0 to 5, to confirm whether the certificate can be properly decrypted (step S720).

The OS is provided with a certificate input API that starts a decryption process whereby the policy storage unit 112, when called, decrypts an indicated certificate. The program owner runs the program that calls the certificate input API on the OS in order to input the certificate into the policy storage unit 112.

If the policy storage unit 112 property decrypts the certificate using one of the 6 public keys (step S720: Yes), then the policy storage unit 112 determines that the registration request is authorized if 1) the priority of the policy information obtained by decryption matches the priority corresponding to the public key used for decryption, and 2) within the policy information obtained by decryption, the combination of a priority, resource, and access conditions does not violate the restriction in the access restriction information (step S730: Yes). In this case, the policy storage unit 112 additionally stores the policy information obtained by decryption (step S740), displays a message indicating completion of registration on the display (step S750), and terminates operations for updating policy information.

In step S720, if the policy storage unit 112 cannot property decrypt the certificate using one of the 6 public keys (step S720: No), or if, in step S730, the policy storage unit 112 does not determine that the registered request is authorized (step S730: No), then without additionally storing new policy information, the policy storage unit 112 displays a message indicating failure of registration on the display (step S760) and terminates operations for updating policy information.

### Modification

The Embodiment describes an example in which the resources 102 are partitioned into three units, i.e. the protected memory 121, shared memory 122, and encryption engine 123. This Modification, however, is an example in which the resources 102 are partitioned into regions designated by any range of physical addresses and used in units of these partitioned regions.

The following description of the Modification focuses on the differences with the Embodiment.

### <Policy Information, Resource Access Information, and Access Restriction Information in the Modification>

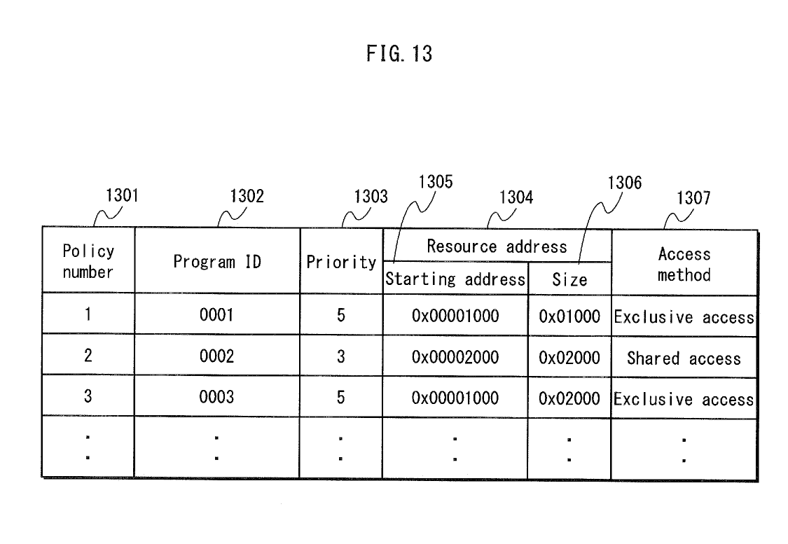

FIG. 13 shows policy information stored in the policy storage unit 112 in the Modification. The policy storage unit 112 stores policy information, which indicates that a program specified by a program ID1302 can access a resource specified by a resource address 1304 at the priority designated by a priority 1303 via an access method indicated by an access method 1307.

The policy information in the Embodiment and the policy information in the Modification differ as follows. In the policy information in the Embodiment, the resources are the protected memory 121, shared memory 122, and encryption engine 123. In the policy information in the Modification, however, the resources are regions designated by physical addresses. Also, the policy information in the Embodiment associates an access method of a resource with each of the three resources, i.e. the protected memory 121, shared memory 122, and the encryption engine 123, yet the policy information in the Modification associates one access method with one resource in a region designated by a physical address.

The resource access information is created by the request receiving unit 111 with reference to the policy information stored by the policy storage unit. As with the policy information, in the resource access information in the Embodiment, there are three resources, i.e. the protected memory 121, shared memory 122, and encryption engine 123, yet in the resource access information in the Modification, the resources are regions designated by physical addresses.

Similarly, the resource access information in the Embodiment associates an access method of a resource with each of the three resources, i.e. the protected memory 121, shared memory 122, and the encryption engine 123, yet the resource access information in the Modification associates one access method with one resource in a region designated by a physical address.

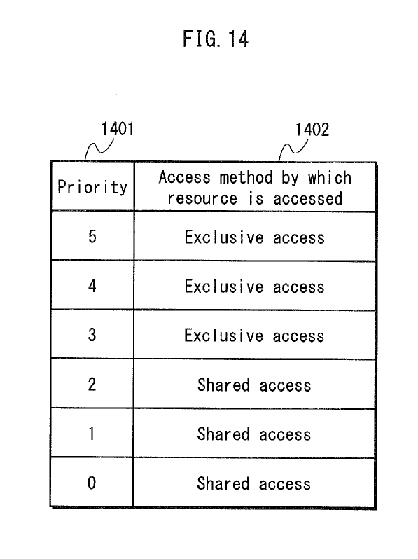

FIG. 14 shows access restriction information stored in the policy storage unit 112 in the Modification.

As shown in FIG. 14, the access restriction information restricts access by a program to a resource in accordance with a priority indicated by the priority 1401.

In the Embodiment, there are three resources, i.e. the protected memory 121, shared memory 122, and encryption engine 123, whereas in access restriction information in the Modification, there is only one resource.

### <Overlap of Resources in the Modification>

In the Embodiment, when resources corresponding to a plurality of programs overlap, the resources corresponding to the plurality of programs are always the same resource. In the Modification, however, the resources that a plurality of programs attempt to access may overlap in a variety of ways.

The cases in which resources may overlap in the Modification are classified into two patterns and described with reference to the drawings. In pattern one, a request is issued to use a resource that includes all of the resources in regions corresponding to a plurality of programs. In pattern two, a request is issued to use a resource included in part of the regions of resources corresponding to a program.

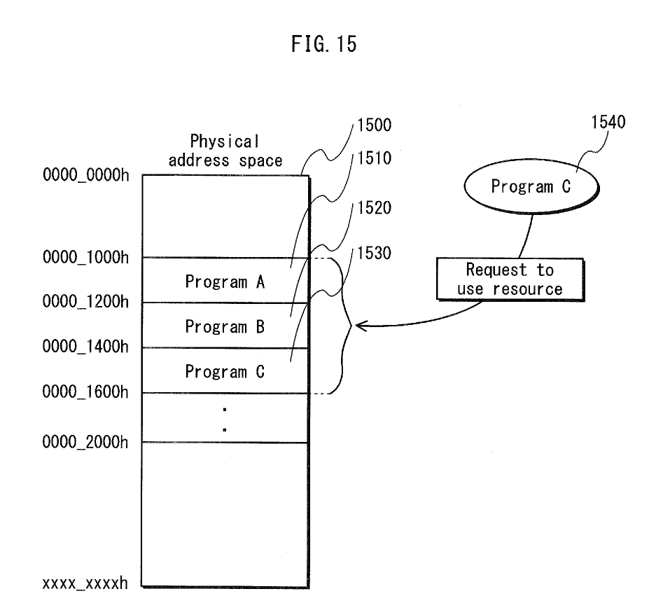

FIG. 15 schematically shows the relationship between regions of resources used by programs when resources overlap as per pattern one in the Modification.

Overlap in pattern one is divided into a variety of cases and explained using the following situation as an example. Programs A, B, and C are running and using resources as follows: in the physical address space 1500, program A uses a resource in a region 0000_{—}1000h-0000_{—}11FFh; program B uses a resource in a region 0000_{—}1200h-0000_{—}13FFh; and program C uses a resource in a region 0000_{—}1400h-0000_{—}15FFh. At this point, a request for use of resources in a region 0000_{—}1000h-0000_{—}15FFh is newly received from program D.

Case 1: the access method by which program D accesses the resource is exclusive.

If the priority of program D is higher than the priorities of all three of the programs A, B, and C, then the permission information rewriting unit 115 adds the resource access information corresponding to program D to the permission information storage unit 113, deletes the resource access information corresponding to programs A, B, and C from the permission information storage unit 113, and adds the resource access information corresponding to programs A, B, and C to the standby information storage unit 114.

If the priority of program D is not higher than the priorities of all three of the programs A, B, and C, then the permission information rewriting unit 115 adds the resource access information corresponding to program D to the standby information storage unit 114.

If the priority of program D is not higher than the priority of Program A, but is higher than the priorities of programs B and C (e.g., priority of program A>priority of program D>priority of program B>priority of program C), then when the resource access information of program A has been deleted by the permission information rewriting unit 115, the resource access information corresponding to program B and C are deleted and added to the standby information storage unit 114, and the resource access information corresponding to program D is added to the permission information storage unit 113.

Case 2: the access method by which program D accesses the resource is shared.

Case 2-1: the access methods by which programs A, B, and C access a resource are all exclusive.

If the priority of program D is higher than the priorities of all three of the programs A, B, and C, then the permission information rewriting unit 115 adds the resource access information corresponding to program D to the permission information storage unit 113, deletes the resource access information corresponding to programs A, B, and C from the permission information storage unit 113, and adds the resource access information corresponding to programs A, B, and C to the standby information storage unit 114.

If the priority of program D is not higher than the priorities of all three of the programs A, B, and C, then the permission information rewriting unit 115 adds the resource access information corresponding to program D to the standby information storage unit 114.

Case 2-2: the access methods by which programs A, B, and C access a resource are a combination of exclusive and shared.

The following describes the case when programs A and B access a resource by exclusive access, and program C accesses a resource by shared access.

If the priority of program D is higher than the priority of all of the programs that access a resource by exclusive access (i.e. programs A and B), then the permission information rewriting unit 115 adds the resource access information corresponding to program D to the permission information storage unit 113 and deletes the resource access information corresponding to programs A and B from the permission information storage unit 113, adding the resource access information corresponding to programs A and B to the standby information storage unit 114.

If the priority of program D is not higher than the priority of all of the programs that access a resource by exclusive access (i.e. programs A and B), then the permission information rewriting unit 115 adds the resource access information corresponding to program D to the standby information storage unit 114.

Case 2-3: the access methods by which programs A, B, and C access a resource are all shared.

The permission information rewriting unit 115 adds the resource access information corresponding to program D to the permission information storage unit 113.

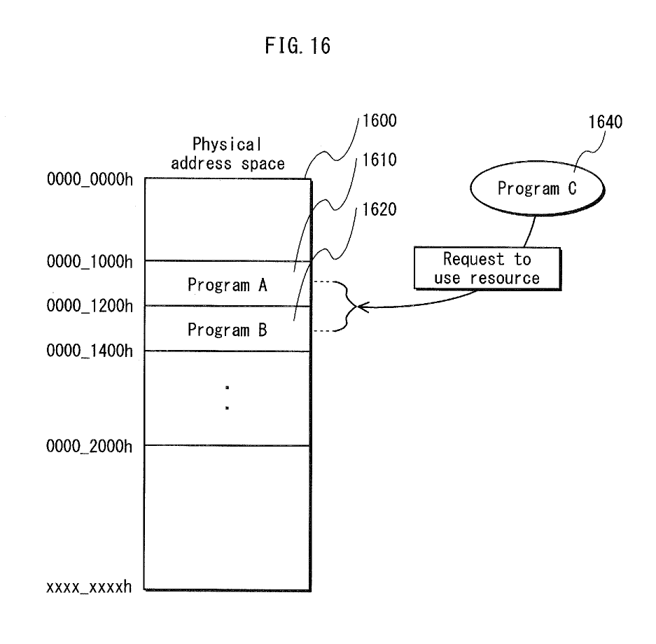

FIG. 16 schematically shows the relationship between regions of resources used by programs when resources overlap as per pattern two in the Modification.

Overlap in pattern two is divided into a variety of cases and explained using the following situation as an example. Programs A and B are running and using resources as follows: in the physical address space 1500, program A uses a resource in a region 0000_{—}1000h-0000_{—}11FFh, and program B uses a resource in a region 0000_{—}1200h-0000_{—}13FFh. At this point, a request for use of resources in a region 0000_{—}1100h-0000_{—}12FFh is newly received from program C.

Case 3: the access method by which program C accesses the resource is exclusive.

If the priority of program C is higher than the priorities of both programs A and B, then the permission information rewriting unit 115 adds the resource access information corresponding to program C to the permission information storage unit 113, deletes the resource access information corresponding to programs A and B from the permission information storage unit 113, and adds the resource access information corresponding to programs A and B to the standby information storage unit 114.

If the priority of program C is not higher than the priorities of both programs A and B, then the permission information rewriting unit 115 adds the resource access information corresponding to program C to the standby information storage unit 114.

Case 4: the access method by which program C accesses the resource is shared.

Case 4-1: the access methods by which programs A and B access a resource are both exclusive.

If the priority of program C is higher than the priorities of both programs A and B, then the permission information rewriting unit 115 adds the resource access information corresponding to program C to the permission information storage unit 113, deletes the resource access information corresponding to programs A and B from the permission information storage unit 113, and adds the resource access information corresponding to programs A and B to the standby information storage unit 114.

If the priority of program C is not higher than the priorities of both programs A and B, then the permission information rewriting unit 115 adds the resource access information corresponding to program C to the standby information storage unit 114.

Case 4-2: the access methods by which programs A and B access a resource are a combination of exclusive and shared.

The following describes the case when program A accesses a resource by exclusive access, and program B accesses a resource by shared access.

If the priority of program C is higher than the priority of program A, then the permission information rewriting unit 115 adds the resource access information corresponding to program C to the permission information storage unit 113, deletes the resource access information corresponding to program A from the permission information storage unit 113, and adds the resource access information corresponding to program A to the standby information storage unit 114.

If the priority of program C is not higher than the priority of program A, then the permission information rewriting unit 115 adds the resource access information corresponding to program C to the standby information storage unit 114.

Case 4-3: the access methods by which programs A and B access a resource are both shared.

The permission information rewriting unit 115 adds the resource access information corresponding to program C to the permission information storage unit 113.

### <Operations When Receiving a Request to Use a Resource in the Modification>

With reference to the drawings, the following is a description of operations in the Modification when receiving a request from a program to use a resource.

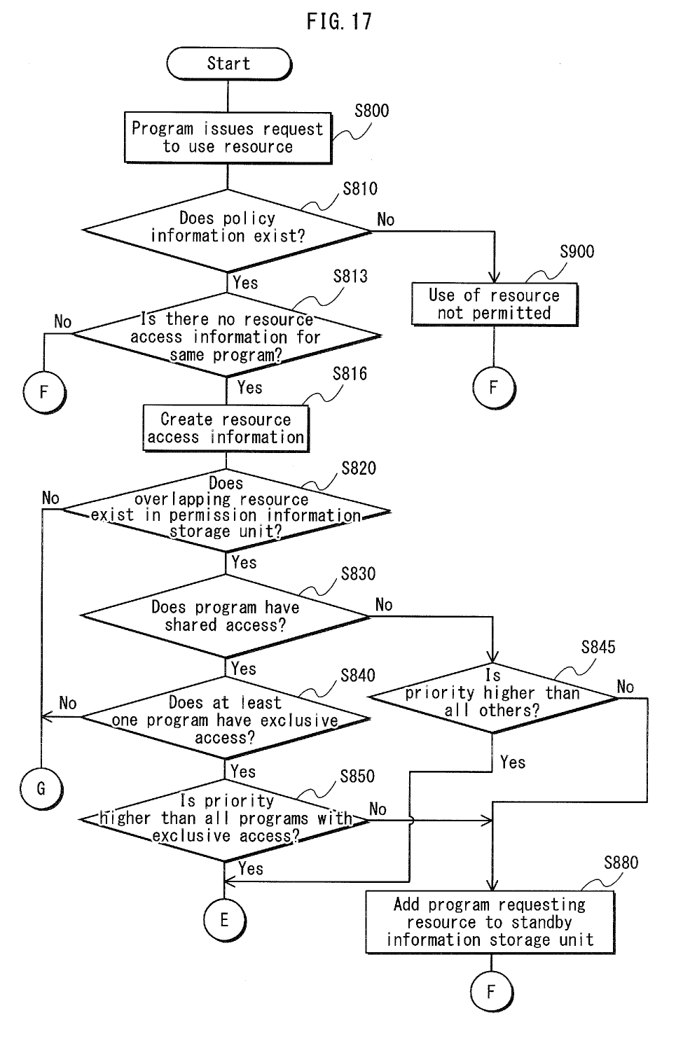

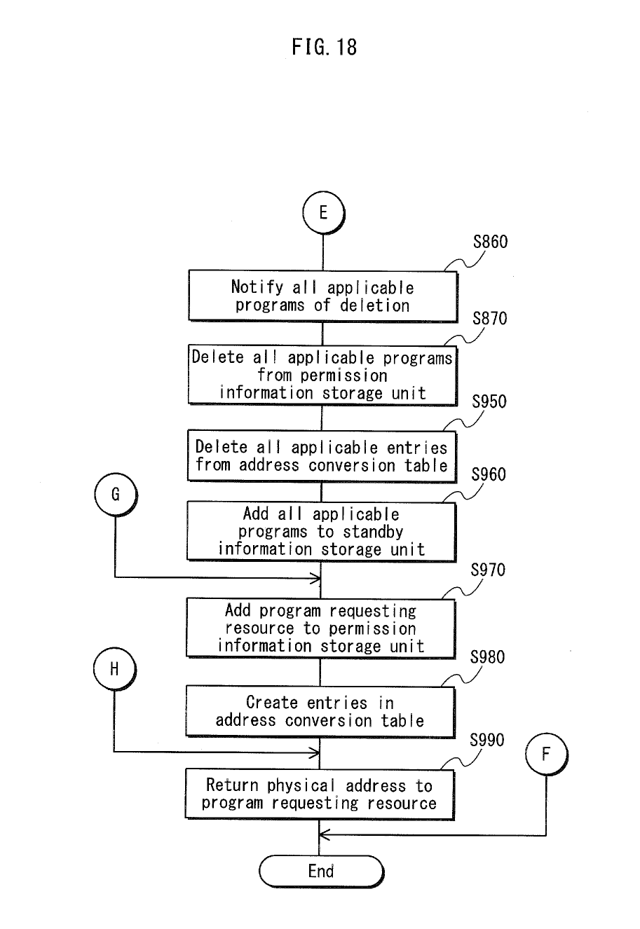

FIGS. 17 and 18 are a flowchart showing when a request to use a resource 102 is received from a program in the group of programs 101.

When a program in the group of programs 101 issues a request to the request receiving unit 111 to use the resources 102 (step S800), the request receiving unit 111 determines whether policy information corresponding to the requesting program exists among the policy information stored by the policy storage unit 112 (step S810). If such policy information does exist (step S810: Yes), the request receiving unit 111 determines whether resource access information corresponding to the requesting program exists in the permission information storage unit 113 (step S813). If corresponding resource access information is not found (step S813: Yes), the request receiving unit 111 creates resource access information corresponding to the requesting program (step S816), thereby receiving the request to use a resource.

When the request receiving unit 111 receives the request to use a resource, the permission information rewriting unit 115 determines whether there is stored, in the permission information storage unit 113, resource access information (overlapping resource access information) indicating a region of a resource (overlapping resource) included in at least part of a region of a resource indicated by the resource access information created by the request receiving unit 111 (new resource access information) (step S820).

If overlapping resource access information is stored in the permission information storage unit 113 (step S820: Yes), then if the program indicated by the new resource access information (hereinafter “new program”) accesses the corresponding resource via shared access (step S830: Yes), and if at least one of the access methods by which the programs indicated by the overlapping resource access information (hereinafter “overlapping programs”) accesses the overlapping resource is exclusive access (step S840: Yes), then the permission information rewriting unit 115 compares (i) the priority of access to the overlapping resource by the new program with (ii) the priorities of access to the overlapping resource (hereinafter “overlapping exclusive priorities”) of the programs, among the overlapping programs, that accesses the resource by exclusive access (hereinafter “overlapping exclusive programs”) (step S850). If the priority of access to the overlapping resource by the new program is higher than all of the overlapping exclusive priorities (step S850: Yes), the permission information rewriting unit 115 notifies all of the overlapping exclusive programs of deletion information (step S860).

If, in step S830, the new program accesses the corresponding resource via exclusive access (step S830: No), the permission information rewriting unit 115 compares the priority of access to the overlapping resource by the new program with the priority of access to the overlapping resource by the overlapping programs (step S845). If the priority of access to the overlapping resource by the new program is higher than all of the priorities by which the overlapping programs access the overlapping resource (step S845: Yes), the permission information rewriting unit 115 notifies all of the overlapping programs of deletion information (step S860).

When notified of deletion information, the overlapping exclusive programs or the overlapping programs (hereinafter “applicable programs”) perform the above-described post-processing and terminate.

After a predetermined time passes after providing notification of deletion information, the permission information rewriting unit 115 deletes the resource access information corresponding to all of the applicable programs (hereinafter referred to as “applicable resource access information”) and the corresponding starting logical addresses from the permission information storage unit 113 (step S870), deletes all of the applicable address conversion table elements from the address conversion table 118 (step S950), and adds all of the applicable resource access information to the standby information storage unit 114 in association with corresponding starting logical addresses (step S960).

Upon adding all of the applicable resource access information to the standby information storage unit 114, the permission information rewriting unit 115 creates address conversion table elements corresponding to new access information, stores new resource access information in the permission information storage unit 113 in correspondence with the created starting logical address (step S970), and adds the created address conversion table elements to the address conversion table 118 (step S980).

Upon executing step S980, or if the request receiving unit 111 finds resource access information corresponding to the requesting program in the permission information storage unit 113 in step S813 (step S813: No), the permission information rewriting unit 115 notifies the request receiving unit 111 of the starting logical address corresponding to the requesting program. The permission information rewriting unit 115 then notifies the requesting program of permission information.

Upon being notified of a starting logical address by the permission information rewriting unit 115, the request receiving unit 111 returns the notified starting logical address to the requesting program as a return value (step S990) and terminates operations for receiving a request to use a resource.

Upon receiving permission information and the starting logical address, the program starts a resource access processing routine.

Upon notifying the new program of a permission notification signal, the permission information rewriting unit 115 creates address conversion table elements based on new access information, adds new resource access information to the permission information storage unit 113 in correspondence with the created starting logical address (step S970), adds the created address conversion table elements to the address conversion table 118 (step S980), and notifies the request receiving unit 111 of the created starting logical address.

Upon being notified of a starting logical address, the request receiving unit 111 returns the notified starting logical address to the new program as a return value (step S990) and terminates operations for receiving a request to use a resource.

In step S845, if the priority of access to the overlapping resource by the new program is not higher than all of the priorities by which the overlapping programs access the overlapping resource (step S845: No), or if, in step S850, the priority of access to the overlapping resource by the new program is not higher than all of the overlapping exclusive priorities (step S850: No), the permission information rewriting unit 115 adds the new resource access information to the standby information storage unit 114 (step S880) and terminates operations for receiving a request to use a resource.

In step S820, if overlapping resource access information is not stored in the permission information storage unit 113 (step S820: No), or if in step S840 the overlapping programs all access the overlapping resource via shared access (step S840: No), the permission information rewriting unit 115 notifies the new program of a permission notification signal, performs the processing in steps S970-S990, and terminates operations for receiving a request to use a resource.

If, in step S810, corresponding policy information does not exist (step S810: No), the request receiving unit 111 stops execution of the program (step S900) and terminates operations for receiving a request to use a resource.

### <Supplementary Explanation>

As one Embodiment of an access control apparatus according to the present invention, an access control apparatus that controls access to a resource by a plurality of programs has been described, as well as a Modification of the access control apparatus. The following modifications are also possible, since the present invention is of course not limited to an access control apparatus exactly as described in the Embodiment above.

(1) In the Embodiment, there are two blocks storing resource access information, the permission information storage unit 113 and the standby information storage unit 114. For example, only one block may instead act as an information storage unit storing resource access information.

In this case, a permission information flag may for example be established. This permission information flag is set to 1 when resource access information corresponds to the resource access information stored by the permission information storage unit 113 in the Embodiment and is set to 0 when resource access information corresponds to the resource access information stored by the standby information storage unit 114 in the Embodiment. Resource access information is stored in correspondence with this permission information flag when being stored in the information storage unit.

Even if there is only one block storing resource access information, referring to the permission information flag that corresponds to a piece of resource access information makes it possible to distinguish whether the piece of resource access information would have been stored in the permission information storage unit 113 or in the standby information storage unit 114 in the Embodiment, and therefore it is possible to achieve the same effects as the Embodiment.

By adopting this structure, the same effects of deleting/adding resource access information from/to the permission information storage unit 113 and the standby information storage unit 114 in the Embodiment can be achieved by simply switching the value of the permission information flag.

(2) In the Embodiment, when the request receiving unit 111 receives a request from a program to use a resource, the request receiving unit 111 refers to information on the program, information on the resource, information on the priority, and information on the access method in the policy information corresponding to the requesting program to create resource access information. To create the resource access information, however, the request receiving unit 111 may refer to information other than the policy information with regards to part or all of the information on the program, information on the resource, information on the priority, and information on the access method.

For example, when a program issues a request to use a resource to the request receiving unit 111, the program may designate data that includes information on the program, information on the resource, information on the priority, and information on the access method. The request receiving unit 111 may then refer to the information on the program, information on the resource, information on the priority, and information on the access method in the data to create the resource access information.

In this context, resource access information is created only when the designated data complies with access restriction information stored by the policy storage unit 112, or when the designated data complies with policy information stored by the policy storage unit 112.

By adopting this structure, the request receiving unit 111 can create resource access information each time a program requests use of a resource, and even when creating resource access information for the same program, the request receiving unit 111 can create different resource access information depending on circumstances.

(3) The Embodiment describes an example in which the access method by which access to resources is permitted in the access restriction information of the policy storage unit 112, and by which access to resources is permitted in the policy information, is either exclusive access or shared access, but other access methods are possible. For example, the access methods may include a multiple method of access that indicates permission to access a resource via a plurality of access methods such as exclusive access, shared access, etc.

By adopting this structure, when the request receiving unit 111 creates resource access information each time a program requests use of a resource, even when creating resource access information for the same program, the request receiving unit 111 can create resource access information with a different access method depending on circumstances.

(4) In the Embodiment, the certificate authority 103 creates a certificate by encrypting policy information, which the certificate authority 103 creates, with a private key that differs for each priority, yet a certificate may be created by a different method.

For example, encryption may be performed with a common private key, regardless of priority, or encryption may be performed without using a private key. Furthermore, a certificate need not be encrypted.

The method of encryption considered most appropriate may be adopted based on the tradeoff between the risk of encryption being cracked and the cost of encryption.

(5) In the Embodiment, when the request receiving unit 111 receives a request from a program to use the resources 102, if there is no policy information corresponding to the requesting program in the policy storage unit 112, execution of the program is stopped, but it is not necessary for execution to be stopped.

In the case that the request receiving unit 111 does not stop execution of the program, the access permitting unit 117 does not permit the program to access the resource. Therefore, unless there is a compelling reason to stop execution of the program, then in a system in which, for example, there is no particular reason to stop execution of the program, it is not problematic to adopt a structure that does not stop execution of the program when there is little need to do so.

(6) When the permission information rewriting unit 115 adds resource access information to the permission information storage unit 113, the permission information rewriting unit 115 notifies the program corresponding to the resource access information of permission information, but it is not necessary to provide such notification.

For example, there is no need to notify a program of permission information if the program starts to access a resource when corresponding address conversion table elements are added to the address conversion table 118 even if the program has not been notified of the permission information.

(7) When deleting resource access information from the permission information storage unit 113, the permission information rewriting unit 115 notifies the program corresponding to the resource access information of deletion information, but it is not necessary to provide such notification.

Even if the permission information rewriting unit 115 does not notify the program of deletion information, and therefore stops an access processing routine without performing interrupt processing, it is not necessary to provide notification of the deletion information if, for example, when restarting a stopped access processing routine, the permission information rewriting unit 115 executes the access processing routine from the start.

(8) When a program terminates a resource access processing routine, the program notifies the permission information rewriting unit 115 of termination of execution. However, it is possible to adopt a structure in which a program does not notify the permission information rewriting unit 115 of termination of execution if, for example, when a resource access processing routine terminates, the OS can detect that the resource access processing routine has terminated and notify the permission information rewriting unit 115 of such termination.

(9) The access restriction information is described above as being included beforehand as part of the policy storage unit 112, but other structures are possible. For example, a structure may be adopted in which access restriction information stored in the policy storage unit 112 is recorded on a non-volatile memory or the like that can be rewritten by an external user, the user thus being able to set access restriction information.

By adopting the above structure, if there is a problem with the access restriction information, a user can update the access restriction information.

(10) The starting logical address is described above as being created by the permission information rewriting unit 115 or the permission information adding unit 116 based on resource access information, but other structures are possible. For example, the policy information may additionally associate a starting logical address with a program, priority, resource, and access method, and the permission information rewriting unit 115 or the permission information adding unit 116 may refer to this policy information stored in the policy storage unit 112 to create a starting logical address.

(11) Note that when a program in the group of programs 101 is notified of deletion information, termination of a program is described above as post-processing, but alternatively, in order to be able to suspend a running resource access processing routine and restart the stopped resource access processing routine, information such as the register used by the resource access processing routine at the time of suspension may be saved in memory, on a hard disk, etc. as the post-processing.

Furthermore, when the permission information adding unit 116 adds resource access information corresponding to such a program to the permission information storage unit 113, and the starting logical address corresponding to the added resource access information is stored in the standby information storage unit 114, the program may be notified of reissued permission information. Upon being notified of reissued permission information, the program may read information that was saved in memory, on a hard disk, etc. and restart the suspended resource access processing routine.

By adopting the above structure, even if a program is notified of deletion information and a resource access processing routine is suspended, upon notification of reissued permission information, the program can restart the resource access processing routine from the point at which it was suspended. The resource access processing routine can thus be executed without wasting the processing up to the point of suspension.

(12) Part of the programs in the OS corresponding to the access control apparatus may be recorded on a computer readable recording medium, such as a flexible disk, hard disk, CD-ROM, MO, DVD, DVD-ROM, DVD-RAM, BD (Blu-ray Disc), semiconductor memory, etc. and may be transmitted via networks, of which telecommunications networks, wire/wireless communications networks, and the Internet are representative.

By doing so, part of the programs in the OS corresponding to the access control apparatus can be installed on a computer system and made to function as the access control apparatus described in the Embodiment.

### INDUSTRIAL APPLICABILITY

The present invention can be widely used in the field of computer systems, in the fields of information devices and household electrical appliances that use a computer system, etc.

### REFERENCE SIGNS LIST

100 access control apparatus
101 group of programs
102 resources
103 certificate authority
111 request receiving unit
112 policy storage unit
113 permission information storage unit
114 standby information storage unit
115 permission information rewriting unit
116 permission information adding unit
117 access permitting unit
118 address table conversion unit
121 protected memory
122 shared memory
123 encryption engine

1-14. (canceled)

15. An access control apparatus for controlling access to resources by a plurality of programs that access a resource after issuing a request to use the resource, the access control apparatus comprising:
a request receiving unit operable to receive a request to use a resource from a program;
an information storage unit storing resource access information that includes program information;
an access permitting unit operable to permit a program to access a corresponding resource only when the program is indicated by the program information included in the resource access information; and
an information rewriting unit operable, when first resource access information, which includes first program information indicating a first program, is stored in the information storage unit, to delete the first resource access information from the information storage unit and add second resource access information, which includes second program information indicating a second program, to the information storage unit upon the request receiving unit receiving a request to use a resource from the second program when a priority predetermined for the second program is higher than a priority predetermined for the first program, wherein
the resource access information associates the program information with access method information that indicates an access method by which a program accesses a resource, and
the information rewriting unit deletes the first resource access information from the information storage unit and adds the second resource access information to the information storage unit in accordance with access method information included in the first resource access information and access method information included in the second resource access information.

16. The access control apparatus of claim 15, wherein
the resource access information associates the program information, the access method information, and resource information, the resource information indicating a resource accessed by a program indicated by the program information, and
when first resource access information, which associates first resource information indicating a first resource with the first program information, is stored in the information storage unit, the information rewriting unit deletes the first resource access information from the information storage unit and adds second resource access information, which associates second resource information indicating a second resource with the second program information, to the information storage unit upon the request receiving unit receiving, from the second program, a request to use a second resource that includes at least part of the first resource when the priority predetermined for the second program is higher than the priority predetermined for the first program.

17. The access control apparatus of claim 16, wherein
when deleting the resource access information from the information storage unit, the information rewriting unit notifies the program indicated by the program information included in the resource access information that permission to access the corresponding resource is revoked.

18. The access control apparatus of claim 17, further comprising
a standby information storage unit storing the resource access information, wherein
the information rewriting unit
adds the first resource access information to the standby information storage unit when adding the second resource access information to the information storage unit, and
when first resource access information is stored in the information storage unit, adds the second resource access information to the standby information storage unit upon the request receiving unit receiving, from the second program, a request to use the second resource that includes at least part of the first resource when the priority predetermined for the second program is not higher than the priority predetermined for the first program.

19. The access control apparatus of claim 18, wherein
the information rewriting unit
adds third resource access information, which associates third resource information indicating a third resource with third program information indicating a third program, to the information storage unit upon the request receiving unit receiving a request to use the third resource from the third program when the third resource does not include resources indicated by resource information included in every piece of resource access information stored in the information storage unit, and
when the third resource access information is stored in the information storage unit, deletes the third resource access information from the information storage unit when execution of the third program terminates.

20. The access control apparatus of claim 19, further comprising
an information adding unit operable, when resource access information has been deleted from the information storage unit, when among pieces of resource access information stored by the standby information storage unit, one or more pieces of permissible resource access information exist, the one or more pieces of permissible resource access information not including any resource indicated by the resource information included in every piece of resource access information stored by the information storage unit, to delete a piece of permissible resource access information with a highest priority, predetermined for a program indicated by corresponding program information, from the standby information storage unit and to add the piece of permissible resource access information to the information storage unit.

21. The access control apparatus of claim 20, wherein
when adding the resource access information to the information storage unit, the information adding unit notifies the program indicated by the program information included in the resource access information of permission to access the corresponding resource.

22. The access control apparatus of claim 18, wherein
the access method information indicates whether a program accesses a resource by shared access, which permits access by other programs, or by exclusive access, which does not permit access by other programs, and
the information rewriting unit deletes the first resource access information from the information storage unit and adds the second resource access information to the information storage unit only when at least one of access method information corresponding to the first resource and access method information corresponding to the second resource indicates exclusive access.

23. The access control apparatus of claim 22, wherein
when resource access information has been deleted from the information storage unit, when the standby information storage unit stores one or more pieces of permissible resource access information, or when among the pieces of resource access information stored by the standby information storage unit, one or more pieces of permissible shared resource access information exist, the one or more pieces of permissible shared resource access information (i) indicating shared access for the access method information and (ii) not including any resource corresponding to resource access information that indicates exclusive access for the access method information among the resource access information stored by the information storage unit, the information adding unit deletes, among the one or more pieces of permissible resource access information and the one or more pieces of permissible shared resource access information, a piece of resource access information with a highest priority, predetermined for a program indicated by corresponding program information, from the standby information storage unit and adds the piece of resource access information to the information storage unit.

24. The access control apparatus of claim 23, further comprising
a policy storage unit that receives a certificate certifying that a specific program, a specific resource, a specific priority, and a combination thereof are authorized and stores policy information that associates authorized resource information indicating the specific resource, authorized program information indicating the specific program, and authorized priority information indicating the specific priority, wherein
the request receiving unit rejects a request to use a resource from a program unless the request (i) is issued by a program indicated by the authorized program information and (ii) is for use of a resource indicated by the authorized resource information associated with the authorized program information,
the priority predetermined for the first program is indicated by the priority information in the policy information for when the first program accesses the first resource, and
the priority predetermined for the second program is indicated by the priority information in the policy information for when the second program accesses the second resource.

25. The access control apparatus of claim 24, wherein
the request receiving unit provides a program, indicated by program information included in resource access information added to the information storage unit, with a logical address used to access a resource corresponding to the program.

26. The access control apparatus of claim 15, wherein
the access permitting unit determines whether to permit access to a resource corresponding to a program when decoding an instruction in the program to read from or write to the resource, the program being indicated by program information included in resource access information, and performs error processing when determining not to permit access.

27. An access control program for causing a computer to function as an access control apparatus for controlling access to resources by a plurality of application programs that access a resource after issuing a request to use the resource, the access control apparatus comprising:
a request receiving unit operable to receive a request to use a resource from an application program;
an information storage unit storing resource access information that includes program information;
an access permitting unit operable to permit an application program to access a corresponding resource only when the application program is indicated by the program information included in the resource access information; and
an information rewriting unit operable, when first resource access information, which includes first program information indicating a first application program, is stored in the information storage unit, to delete the first resource access information from the information storage unit and add second resource access information, which includes second program information indicating a second application program, to the information storage unit upon the request receiving unit receiving a request to use a resource from the second application program when a priority predetermined for the second application program is higher than a priority predetermined for the first application program, wherein
the resource access information associates the program information with access method information that indicates an access method by which an application program accesses a resource, and
the information rewriting unit deletes the first resource access information from the information storage unit and adds the second resource access information to the information storage unit in accordance with access method information included in the first resource access information and access method information included in the second resource access information.

28. An access control method for causing an access control apparatus, which comprises an information storage unit storing resource access information that includes program information, a request receiving unit, an access permitting unit, and an information rewriting unit, to control access to resources by a plurality of programs that access a resource after issuing a request to use the resource, the access control method comprising the steps of:
the request receiving unit receiving a request to use a resource from a program;
the access permitting unit permitting a program to access a corresponding resource only when the program is indicated by the program information included in the resource access information; and
the information rewriting unit deleting, when first resource access information, which includes first program information indicating a first program, is stored in the information storage unit, the first resource access information from the information storage unit and adding second resource access information, which includes second program information indicating a second program, to the information storage unit upon the request receiving unit receiving a request to use a resource from the second program when a priority predetermined for the second program is higher than a priority predetermined for the first program, wherein
the resource access information associates the program information with access method information that indicates an access method by which a program accesses a resource, and
the information rewriting unit deletes the first resource access information from the information storage unit and adds the second resource access information to the information storage unit in accordance with access method information included in the first resource access information and access method information included in the second resource access information.
